(19) United States
(12) Patent Application Publication
(10) Pub. No.: US 2006/0185933 A1
(43) Pub. Date: Aug. 24, 2006

(54) Ladder storage and support assembly

(76) Inventor: Marcel Thibault, Mont St-Hilaire (CA)

Correspondence Address: Eric Fincham, 316 Knowlton Road, Lac Brome, QC, J0E 1V0, CA

(21) Appl. No.: 11/350,632

(22) Filed: Feb. 9, 2006

(30) Foreign Application Priority Data
Feb. 10, 2005 (CA) 2,496,975

(51) Int. Cl. E06C 5/00

(52) U.S. Cl. 182/127

(57) ABSTRACT

A ladder storage and support device which comprises first and second frames, the second frame being designed to lie adjacent a side of a vehicle and optionally being secured thereto, the first frame being pivotably connected to the second frame at respective bottoms such that the first frame can pivot from a first ladder securing position to a second loading position, the first frame having ladder retaining members thereon. The device may be either secured to the side of the vehicle or alternatively, a roof assembly may move the device from a roof top position to a position adjacent a vehicle side.

### FIELD OF THE INVENTION

The present invention relates to a ladder storage assembly and more particularly, relates to a ladder storage and support device which may be utilized either for the side or roof of a vehicle.

### BACKGROUND OF THE INVENTION

Ladders are carried by many service vehicles wherein the ladders are needed for use by electricians, construction workers, etc. Typical of such vehicles are those operated by the telephone company, the gas company, cable and television companies, etc. The ladders are required for gaining access to various facilities which are typically mounted on poles or some other structure.

For many years, the ladders were carried on top of the vehicles on an ordinary roof rack as this was considered the most practical option. However, these vehicles have become higher and with the increasing weight of some ladders, it becomes extremely difficult and dangerous to reach and remove the ladders from the vehicle top.

Numerous devices have been developed and used for receiving and securely storing ladders for stationary storage and/or for transportation. These devices must address a number of considerations which are unique to storing and securing ladders. Thus, ladders are bulky, of a considerable length and relatively heavy.

Generally, there are choices as to the particular design and placement of the ladder rack storage system. Thus, with the increased height of some vehicles, it has been proposed in the art to store the ladder on the side of the vehicle. However, unless properly designed, the aesthetics and other problems lead many corporations to veto such a design. Irrespective of the placement of the rack, the rack must provide ready access to the ladder as often only one person is trying to manipulate a heavy and/or long ladder onto the ladder rack.

### SUMMARY OF THE INVENTION

It is an object of the present invention to provide a ladder storage assembly and system wherein a storage and support device may be placed either on the side panel of a vehicle or alternatively on the roof of a vehicle.

According to one aspect of the present invention, there is provided a ladder storage and support device comprising first and second frame means, each of the frame means having a respective top and bottom, the second frame means being designed to lie adjacent a side of the vehicle, the first frame means being pivotably connected to the second frame means proximate their respective bottoms, the first frame means being pivotably moveable from a first ladder securing position wherein the first and second frame means lay adjacent each other and a second loading position wherein the first frame means is pivoted outwardly and downwardly to permit access to the ladder, the first frame means having upper and lower ladder retaining means, the upper retaining means holding the ladder when the first frame means is in an opened position and the lower securing means holding the ladder when the first frame means is in a closed position and at least one tensioning means secured to the first frame means for aiding in the movement thereof.

In a further aspect of the present invention, in a vehicle having a side panel, there is provided an improvement comprising a ladder storage and support device, the ladder storage and support device comprising first and second frame means, the second frame means being secured to the side panel of the vehicle, each of the first and second frame means having a respective top and bottom, the first frame means being pivotably connected to the second frame means proximate their respective bottoms, the first frame means being pivotably movable from a first ladder securing position wherein the first and second frame means lay adjacent each other and a second loading position wherein the first frame means is pivoted outwardly and downwardly to permit access to the ladder, the first frame means having upper and lower ladder retaining means, the upper retaining means holding the ladder when the first frame means is in an opened position and the lower securing means holding the ladder when the first frame means is in a closed position, and tensioning means secured to the first frame means for aiding in the movement thereof.

In a still further aspect of the present invention, in a vehicle having a roof and a side panel and a ladder storage and support device, there is provided the improvement comprising a first assembly on the roof, the first assembly being arranged to move a ladder storage and support device between a position on top of the roof to a position adjacent the side panel, the ladder storage and support device comprising, first and second frame means, each of the frame means having a respective top and bottom, the second frame means being designed to lie adjacent a side of the vehicle, the first frame means being pivotably connected to the second frame means proximate their respective bottoms, the first frame means being pivotably moveable from a first ladder securing position wherein the first and second frame means lay adjacent each other and a second loading position wherein the first frame means is pivoted outwardly and downwardly to permit access to the ladder, the first frame means having upper and lower ladder retaining means, the upper retaining means holding the ladder when the first frame means is in an opened position and the lower securing means holding the ladder when the first frame means is in a closed position, and tensioning means secured to the first frame means for aiding in the movement thereof.

The arrangement of the present invention permits a ladder storage and support device to either be placed on the side of a vehicle or alternatively, to be lowered to the side of a vehicle from a roof top position. In either case, the ladder storage and support device is substantially identical.

As mentioned above, the ladder storage and support device comprises first and second frame means. In the instance wherein the device is secured to the side of a vehicle, it is the second frame means that are so attached. When used in the roof top embodiment, the second frame means lies adjacent a side panel of the vehicle after being lowered there by a roof top assembly.

The first and second frame means are pivotably secured at lower portions thereof. In this regard, the terms upper and lower will be used to describe positions when the first and second frame means are secured together and they are in a position either secured to the side panel of a vehicle or lying adjacent thereto.

As mentioned, the first and second frame means are in a ladder storage position when they are lying adjacent to each other with the ladder therebetween. For purposes of gaining access to the ladder, the first frame means may be lowered through its pivotal connection to the second frame means to a position whereby the ladder may be loaded or unloaded from the device. It will be understood that the first frame means preferably does not pivot through a full 180°, but rather to an angle of between 90° and 170°. The degree of pivoting may be controlled by suitable stop means or more preferably, by the design placement of the tensioning means—i.e. the travel length of the piston rod where piston means are employed.

The tensioning means may either be hydraulic or pneumatic pistons and many such suitable pistons are known in the art. Preferably, the pistons extend between the first and second frame means though it would also be possible to utilize pistons attached to the vehicle side panel. Alternatively, a spring loaded arrangement may be utilized.

### BRIEF DESCRIPTION OF THE DRAWINGS

Having thus generally described the invention, reference will be made to the accompanying drawings illustrating embodiments thereof, in which:

FIG. 1a is a perspective view of the storage mechanism of the ladder storage and support system;

FIG. 1b is a perspective view of the support mechanism of the ladder storage and support system;

FIG. 2 is a side elevational view of both mechanisms of the ladder storage and support assembly on the roof of a vehicle;

FIG. 3 is a perspective view of the support mechanism;

FIG. 4 is a perspective view thereof in a partially opened second portion;

FIG. 5 is a further perspective view thereof;

FIG. 6 is a side elevational view showing operation of the ladder storage and support assembly; and

FIG. 7 is a side elevational view of the ladder storage and support assembly in a fully opened position.

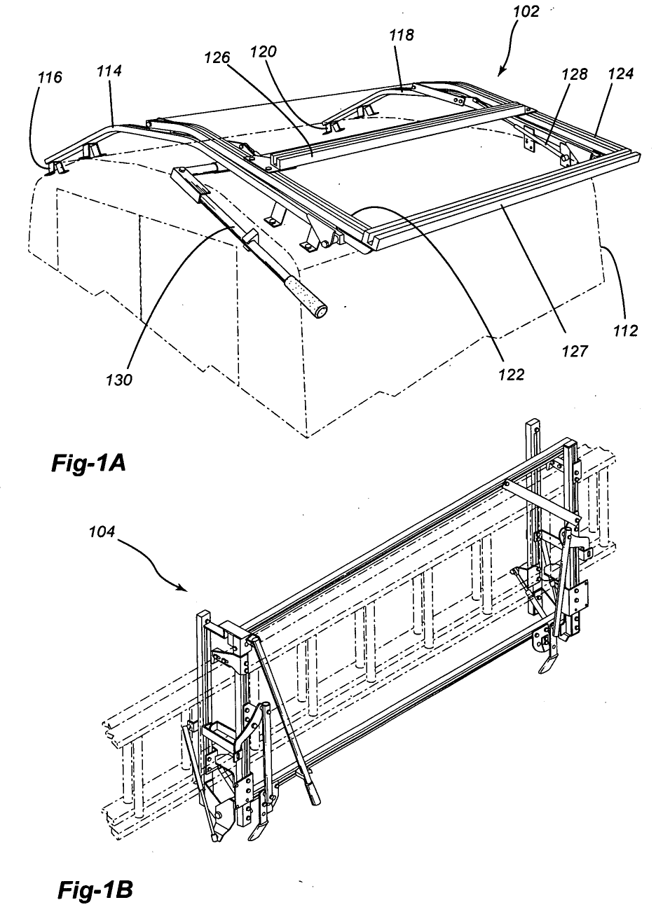

### DETAILED DESCRIPTION OF THE DRAWINGS

The ladder storage and support system is generally designated by reference numeral 110 and includes a first assembly 102 which moves a ladder storage device into a roof storage arrangement.

The first assembly 102 is designed to be attached to a vehicle 112. It includes a first rail 114 mounted on supports 116 which are secured to the roof of the vehicle. A second parallel rail 118 rest on supports 120.

Also provided are a pair of top rails 122 and 124 which are connected together by means of a first traverse member 126 and a second traverse member 127. A pair of cylinders 128 are provided.

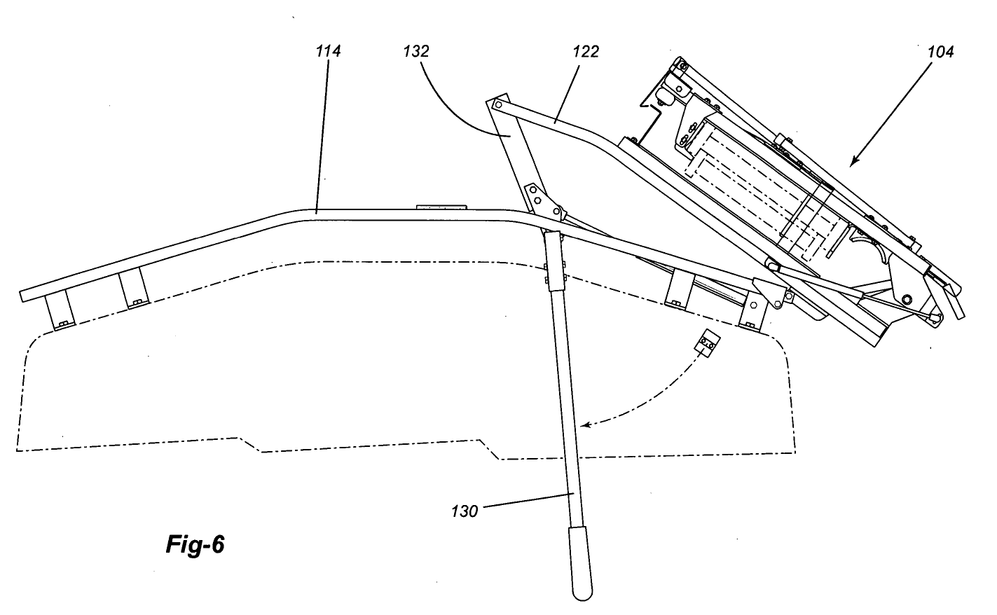

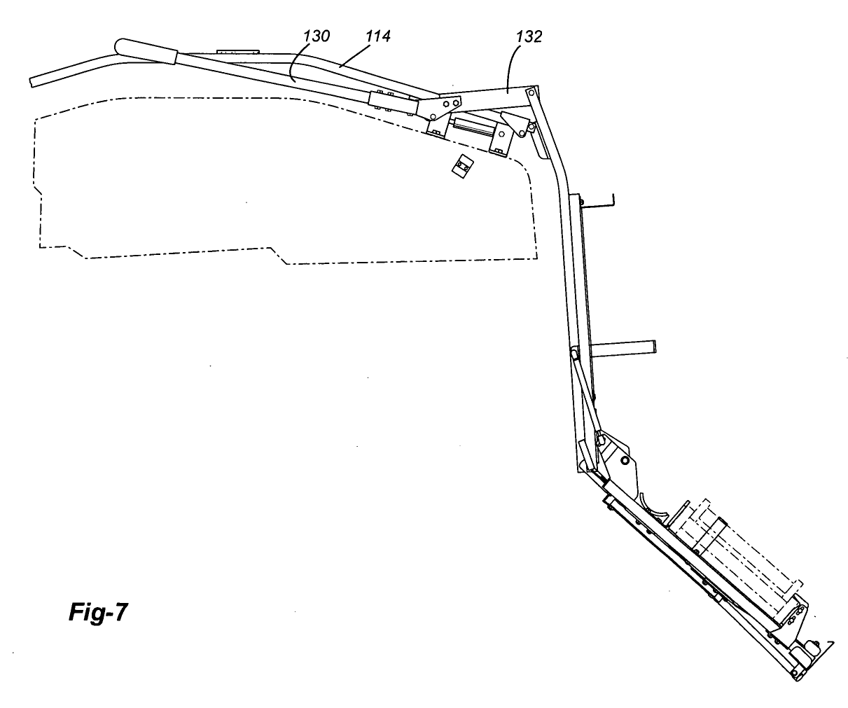

There is also provided a handle member 130 which is connected to a pair of linking arms 132 which in turn are connected to an end of top rails 122, 124. The arrangement is such that movement of the handle from the storage position shown in FIG. 6 will cause the linking arms to extend the end of top rails 122, 124 upwardly such that the ladder storage support and mechanism 104 can be moved to the side of the vehicle as shown in FIG. 7.

Reference will now be had to the ladder storage support and mechanism.

A second frame portion 10 is comprised of a pair of vertical mounting rails 12, 12′.

An L-shaped bracket 16 extends outwardly from rail 12 and has a main portion 18 with an end flange 20.

Situated below bracket 16 is a second bracket 22 which has a central portion 24, a first end portion 26 secured to vertical mounting rail 12, and a second end flange portion 28. A like bracket 22′ is provided for vertical mounting rail 12′. Also secured to vertical mounting rails 12, 12′ are mounting plates 30, 30′.

Also secured to vertical mounting rails 12, 12′ are L-shaped brackets 32, 32′ for reasons which will be discussed hereinbelow. Similarly, interconnecting elements 34, 34′ are mounted on vertical mounting rails 12, 12′ for interconnecting the first and second frame portions as it will be discussed in greater detail hereinbelow. Rear mounting bracket 36 is connected to the back of vertical mounting rail 12. A like rear mounting bracket (not shown) is also associated with vertical mounting rail 12′.

First frame portion 44 is comprised of a pair of vertical rails 46, 46′ which are interconnected at the upper end by an upper horizontal rail 48 and at the lower end by a lower horizontal end 50.

Mounted on vertical rails 46, 46′ are upper brackets 52, 52′ respectively. As will be seen, secured to brackets 52, 52′ are retaining members 58, 58′, the retaining members being secured by bolts 60, 60′.

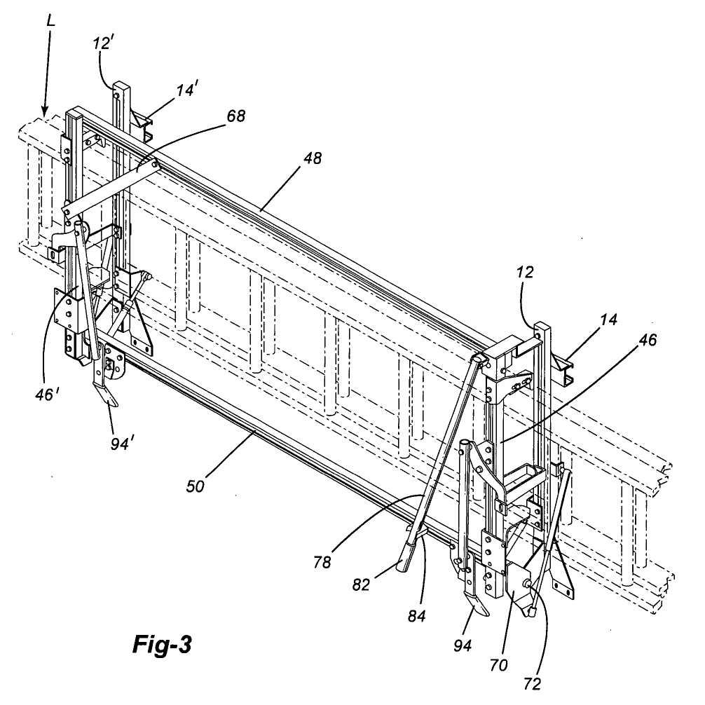

As may be seen in FIG. 3, there is also supplied a lower bracket 62, which is secured to vertical rail 46. Also secured to vertical rails 46, 46′ are ladder support members 66, 66′.

Situated at the lower portion of vertical rail 46, 46′ are interconnecting elements 70 which, as may seen, are secured to respective interconnecting elements 34, 34′ by means of a pivot bolt 72.

Power assist means are provided by means of a first hydraulic cylinder 74 extending between bracket 36 and a lower portion of second interconnecting element 70 and a second hydraulic cylinder 76 having one end secured to bracket 32 and interconnecting element 70. Cylinders 74′, 76′ are supplied on the other side.

As seen in FIG. 3, a reinforcing bar 68 may extend between upper horizontal rail 48 and vertical rail 46′.

To assist in moving the first frame portion into and out of a ladder retaining position, there is provided a rod 78 which is connected to a bracket 80 secured to the top of vertical rail 46. At its distal end, rod 78 is provided with a handle portion 82 with the rod being held by a bracket 84 on lower horizontal rail 50. In operation, first frame portion 44 may be lowered to an opened position by removing rod 78 from bracket 84 and pulling on the same. The first frame portion will then lower as indicated by arrow 90 in FIG. 6. The ladder L may then be placed and held on first frame portion 44 by means of ladder support means 66, 66′ and retaining members 58, 58′. The ladder is secured so that one of the steps is retained between brackets 22 and 62 to prevent sliding movement of the ladder.

Subsequently, the assembly may easily be lifted upwardly with assistance from hydraulic cylinders 74, 74′, 76, 76′.

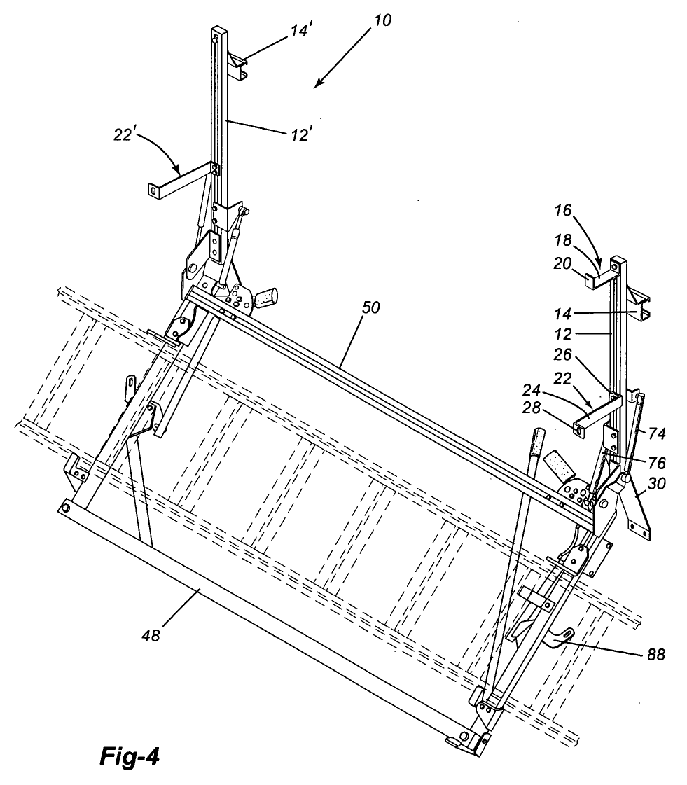

In order to retain the first frame portion 44 in a closed position, there is provided a locking assembly which comprises a first member 86 pivotably connected to bracket 64. Member 86 includes a hook portion 88 at one end thereof. At the other end, member 86 is pivotably connected to rod 92. A handle portion 94 is connected to the frame and pivotably connected to the other end of rod 92. Thus, hook portion 88 is designed to engage bracket 22 as may be seen in FIGS. 3 and 4.

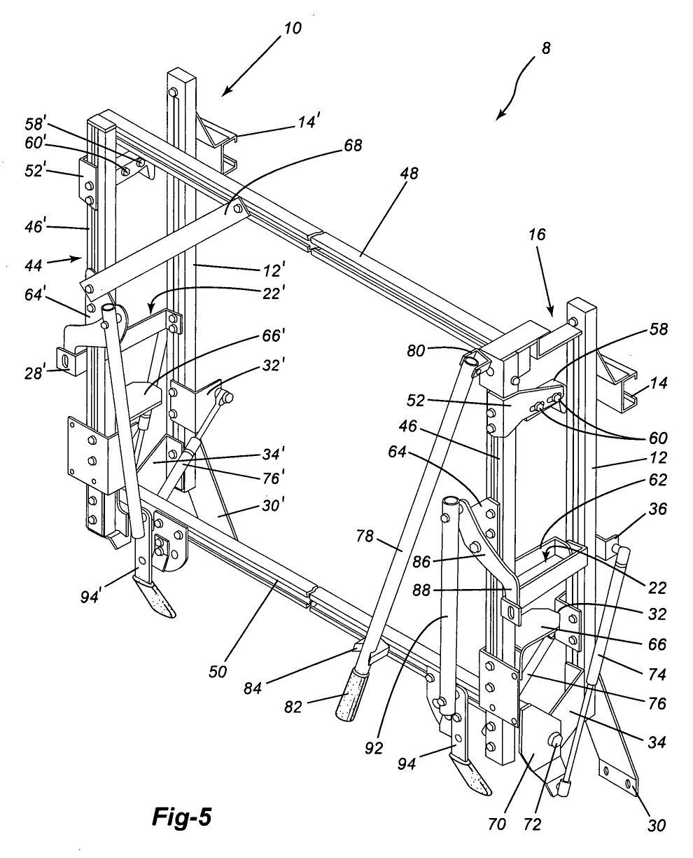

At its upper extremity, vertical rail 46 may be provided with a hook shaped portion 96 as seen in FIG. 5.

In order to secure the locking assembly in a locked position, a lock or other similar device may be used to secure handle 94 in a locked position.

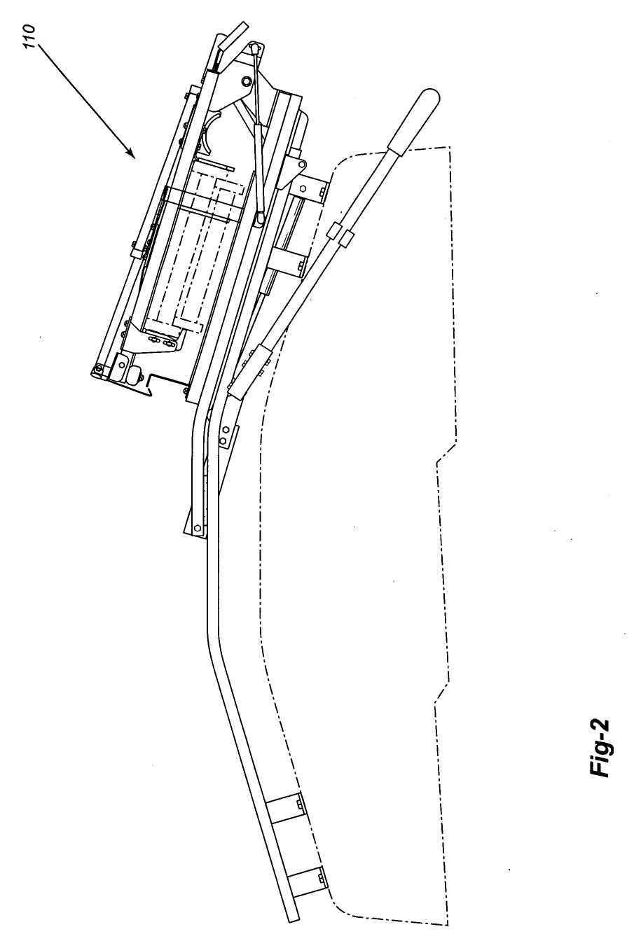

Subsequently, the handle 130 is operated to bring the ladder support mechanism back up to the storage position as shown in FIG. 2.

It will be understood that the above described embodiments are for purposes of illustration only and the changes and modifications may be made thereto without departing from the spirit and scope of the invention.

I claim:

1. A ladder storage and support device comprising:
first and second frame means, each of said frame means having a respective top and bottom, said second frame means being designed to lie adjacent a side of said vehicle, said first frame means being pivotably connected to said second frame means proximate their respective bottoms;
said first frame means being pivotably moveable from a first ladder securing position wherein said first and second frame means lay adjacent each other and a second loading position wherein said first frame means is pivoted outwardly and downwardly to permit access to said ladder;
said first frame means having upper and lower ladder retaining means, said upper retaining means holding said ladder when said first frame means is in an opened position and said lower securing means holding said ladder when said first frame means is in a closed position; and
at least one tensioning means secured to said first frame means for aiding in the movement thereof.

2. The device of claim 1 further including locking means to secure said first and second frame means together when in said closed position.

3. The device of claim 1 wherein said tensioning means comprise piston means having a first pair of pistons extending from a first side of said second frame means to a first side of said first frame means.

4. The device of claim 3 wherein said piston comprises at least one pneumatic cylinder.

5. The device of claim 3 wherein said piston comprises at least one hydraulic cylinder.

6. The device of claim 1 further including a handle secured to a rod, said rod being secured to an upper portion of said first frame means.

7. The device of claim 1 further including attachment means on said second frame for attaching said second frame to a vehicle.

8. The device of claim 3 wherein said piston means comprises first and second sets of pistons extending between said first and second frames, a first set of pistons being located on one side of said frames and a second set of pistons being located on a second side of said frames.

9. The device of claim 1 further including means for moving said first and second frame means when in a closed position to a position on a vehicle roof.

10. The device of claim 2 wherein said second frame means comprises first and second vertically extending members designed to be secured to a position on a side of a vehicle.

11. In a vehicle having a side panel, the improvement comprising a ladder storage and support device, said ladder storage and support device comprising:
first and second frame means, said second frame means being secured to said side panel of said vehicle, each of said first and second frame means having a respective top and bottom, said first frame means being pivotably connected to said second frame means proximate their respective bottoms;
said first frame means being pivotably movable from a first ladder securing position wherein said first and second frame means lay adjacent each other and a second loading position wherein said first frame means is pivoted outwardly and downwardly to permit access to said ladder;
said first frame means having upper and lower ladder retaining means, said upper retaining means holding said ladder when said first frame means is in an opened position and said lower securing means holding said ladder when said first frame means is in a closed position; and
tensioning means secured to said first frame means for aiding in the movement thereof.

12. The improvement of claim 11 further including locking means to secure said first and second frame means together when in said closed position.

13. The device of claim 11 wherein said tensioning means comprises piston means having first and second pairs of pistons, a first pair of pistons being located on respective first sides of said first and second frame means, and a second pair of pistons being located on respective second sides of said first and second frame means.

14. In a vehicle having a roof and a side panel and a ladder storage and support device, the improvement comprising a first assembly on said roof, said first assembly being arranged to move a ladder storage and support device between a position on top of said roof to a position adjacent said side panel, said ladder storage and support device comprising:
first and second frame means, each of said frame means having a respective top and bottom, said second frame means being designed to lie adjacent a side of said vehicle, said first frame means being pivotably connected to said second frame means proximate their respective bottoms;
said first frame means being pivotably moveable from a first ladder securing position wherein said first and second frame means lay adjacent each other and a second loading position wherein said first frame means is pivoted outwardly and downwardly to permit access to said ladder;
said first frame means having upper and lower ladder retaining means, said upper retaining means holding said ladder when said first frame means is in an opened position and said lower securing means holding said ladder when said first frame means is in a closed position; and
tensioning means secured to said first frame means for aiding in the movement thereof.

15. The vehicle of claim 14 wherein said tensioning means and piston means comprising a first pair of pistons extending from a first side of said second frame means to a first side of said first frame means.

16. The vehicle of claim 15 wherein said first frame means can pivot with respect to said second frame means through an angle of between 90° to 170°.
